(19) United States
(12) Patent Application Publication
(10) Pub. No.: US 2007/0273717 A1
(43) Pub. Date: Nov. 29, 2007

(54) MULTI-FUNCTION PERIPHERAL DEVICE

(75) Inventors: Chen-Tsai Tsai, Taipei (TW); Keng-Wei Shih, Taipei (TW); Hsuan-Yang Lin, Taipei (TW)

Correspondence Address: WORKMAN NYDEGGER, 60 EAST SOUTH TEMPLE, 1000 EAGLE GATE TOWER, SALT LAKE CITY, UT, 84111, US

(73) Assignee: LITE-ON TECHNOLOGY CORPORATION, Taipei (TW)

(21) Appl. No.: 11/557,893

(22) Filed: Nov. 8, 2006

(30) Foreign Application Priority Data
May 24, 2006 (TW) 095118503

(51) Int. Cl. B41J 3/00

(52) U.S. Cl. 347/2

(57) ABSTRACT

A multi-function peripheral device is provided. The device includes a first printing unit, a second printing unit, and a scanning unit, wherein the second printing unit and the scanning unit are juxtaposed above the first printing unit, and a paper exit disposed on the device is shared by the first printing unit and the second printing unit. Accordingly, the size of the device is reduced, and the minimization requirement for the device is achieved.

### CROSS-REFERENCE TO RELATED APPLICATIONS

This non-provisional application claims priority under 35 U.S.C. § 119(a) on Patent Application No(s). 095118503 filed in Taiwan, R.O.C. on May 24, 2006, the entire contents of which are hereby incorporated by reference.

### BACKGROUND OF THE INVENTION

1. Field of Invention

The present invention relates to a multi-function peripheral device, and more particularly to the arrangement of printing and scanning units in a multi-function peripheral device for minimizing the size of the device.

2. Related Art

Normally, an office has laser printers, inkjet printers and scanners, which are respectively connected to computers to provide a complete input-output solution. To enable a single computer to control all of the aforementioned peripheral devices, related inventions, such as Taiwan utility model No. M254662, are provided to integrate various devices. No. M254662 provides a “scanning copier with selectable printers”, which includes a scanning module installed to in a housing, and two printers externally connected or installed inside the housing. The scanning copier is connected to a computer, such that the computer can control the scanning module and the two printers of the scanning module.

No. M254662 integrates various modules or devices and controls them with a single computer, but it cannot solve the problem of the space occupied by these modules or devices. To solve the problem that the multiple peripheral devices are large in size and occupy too much space, a common approach now is to integrate various functions into a single device to form a multi-function peripheral device. The multi-function peripheral device provides functions of scanning and printing through a single device, and can even use the scanning and printing functions to realize the function of document fax. A conventional approach is to integrate a scanning unit and an inkjet printing unit into a single multi-function peripheral device. The multi-function peripheral device has only one printing unit. If an inkjet printing unit is applied as the printing unit, the cost for consumable supplies, such as ink or printerheads, is high, and the printing speed of the inkjet printing unit is low. If a laser printing unit is applied as the printing unit, the performance of color printing is poor, and the cost for a laser printing unit with the color printing function is expensive now. Therefore, the preferred solution is to integrate a plurality of printing units in a multi-function peripheral device to adapt to various printing requirements.

FIG. 1 is a schematic view of the arrangement of various units in a conventional multi-function peripheral device. The multi-function peripheral device includes a scanning unit 10, an inkjet printing unit 30, and a laser printing unit 50. The scanning unit 10, the inkjet printing unit 30 and the laser printing unit 50 are stacked together in sequence, and are connected to a controlling device. The controlling device is connected to a computer for the computer controlling these units. However, the conventional multi-function device is made up of three independent units stacked together; therefore the size of the device is large. Moreover, a paper feed tray 51 of the laser printing unit 50 is disposed under the laser printing unit 50, a paper feed tray 31 of the inkjet printing unit 30 is disposed above the laser printing unit 50, and a paper exit 53 of the laser printing unit 50 and a paper exit 33 of the inkjet printing unit 30 are independent from each other. Therefore, the structure of the multi-function peripheral device is complicated, and the size of it is difficult to be reduced.

### SUMMARY OF THE INVENTION

Accordingly, an object of the present invention is to provide a multi-function peripheral device, which can further reduce the size of the entire device through arranging the positions of various units.

To achieve the aforementioned object, the present invention provides a multi-function peripheral device, which includes a first printing unit, a second printing unit, and a scanning unit. The second printing unit is disposed above the first printing unit, wherein a paper support for supporting a piece of a paper is disposed on a first side of the second printing unit, such that the piece of paper enters the second printing unit from the side of the second printing unit. The scanning unit is disposed on a second side of the second printing unit, and juxtaposed above the first printing unit together with the second printing unit. In practice, the first printing unit can be a laser printing unit, which meets the requirement of large-quantity black and white document printing. The second printing unit can be a color inkjet printing module, which meets the requirement of color printing. As the quantity of color printing is relatively small, a paper feed tray for the second printing unit can be omitted, and the paper can be picked up from the paper support on the side, thus the space occupied by the paper feed tray is reduced.

The advantage of the invention is that various functions are integrated into the multi-function peripheral device of the present invention, while the size of the multi-function peripheral device is effectively reduced through arranging the positions of various units that provide those functions.

Features and examples of the present invention are illustrated in detail below with reference to the accompanying drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is a schematic view of a conventional multi-function peripheral device;

FIG. 2 is a schematic view of the multi-function peripheral device of an embodiment of the present invention; and

FIG. 3 is a schematic view of the paper feeding of the first printing unit and the second printing unit of the embodiment of the present invention.

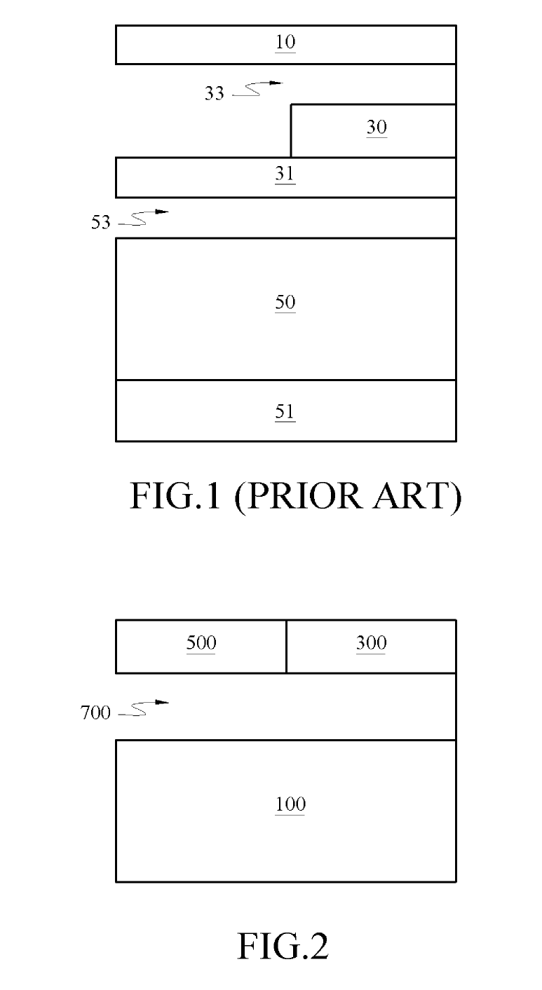

### DETAILED DESCRIPTION OF THE INVENTION

Referring to FIG. 2, a multi-function peripheral device of an embodiment of the invention is provided. The multi-function peripheral device includes a first printing unit 100, a second printing unit 300, and a scanning unit 500. The second printing unit 300 and the scanning unit 500 are juxtaposed above the printing unit 100, and a paper exit 700 is disposed between the first printing unit 100 and the second printing unit 300, such that the paper exit 700 is shared by the first printing unit 100 and the second printing unit 300.

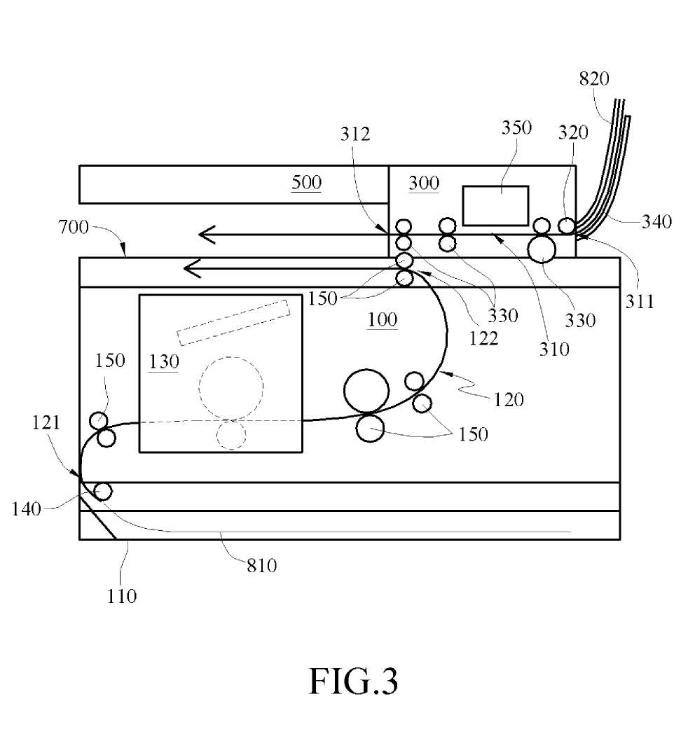

FIG. 3 is a schematic view of the paper feeding of the first printing unit 100 and the second printing unit 300 of the embodiment of the present invention. The first printing unit 100 can be a laser printing unit while the second printing unit 300 is an inkjet printing unit.

The first printing unit 100 includes a paper feed tray 110, a first paper feeding track 120, a first printing module 130, a first paper pickup assembly 140, and a first paper feeding assembly 150. The paper feed tray 110 is disposed at the bottom of the first printing unit 100 for storing a plurality of pieces of to-be-printed blank paper, a paper-in end 121 of the first paper feeding track 120 is connected to the paper feed tray 110. A paper-out end 122 of the first paper feeding track 120 is connected to the paper exit 700. The first paper pickup assembly 140 is disposed at the paper-in end 121 of the first paper feeding track 120 to pickup a piece of paper 810 in the paper feed tray 110 and feed the piece of paper 810 into the first paper feeding track 120.

The first paper feeding assembly 150 is disposed on two sides of the first paper feeding track 120 for feeding the piece of paper 810 in the first paper feeding track 120 from the paper-in end 121 to the paper-out end 122. As the paper-out end 122 is connected to the paper exit 700, the piece of paper 810 can reach the paper exit 700. The first printing module 130 is disposed in the middle section of the first paper feeding track 120 for performing a printing process on the piece of the paper 810, when the piece of paper 810 passes the first printing module 130 via the first paper feeding track 120, it can be printed by the first printing module 130.

As described above, the second printing unit 300 can be an inkjet printing unit. The second printing unit 300 includes a second paper feeding track 310, a second paper pickup assembly 320, a second paper feeding assembly 330, a paper support 340, and a second printing module 350. The second paper feeding track 310 has a paper-in end 311 and a paper-out end 312, wherein the paper-in end 311 is disposed on one side of the second printing unit 300, corresponding to one side edge of the multi-function peripheral device. The paper support 340 is disposed on a first side of the second printing unit 300 for supporting to-be-printed blank paper 820, and the paper-in end 311 is connected to the paper support 340.

The second pickup assembly 320 is disposed at the paper-in end 311 of the second feeding track 310 to pickup a piece of the blank paper 820 on the paper support 340, such that the piece of blank paper 820 enters the second paper feeding track 310 from one side of the second printing unit 300. The second paper feeding assembly 330 is disposed on two sides of the second paper feeding track 310 for feeding the piece of blank paper 820 from the paper-in end 311 to the paper-out end 312. As the paper-out end 312 is connected to the paper exit 700, the piece of blank paper 820 can reach the paper exit 700. The second printing module 350 is disposed in the middle section of the paper feeding track 310 for performing a printing process on the piece of the blank paper 820, when the piece of paper 820 passes the second printing module 350 via the second paper feeding track 310, it can be printed by the second printing module 350.

The scanning unit 500 is disposed on a second side of the second printing unit 300, such that the scanning unit 500 is juxtaposed above the first printing unit 100 together with the second printing unit 300. As the paper-out ends 122, 312 of the first printing unit 100 and the second printing unit 300 are connected to the paper exit 700, the paper exit 700 is shared by the first printing unit 100 and the second printing unit 300. Therefore, the height of the first printing unit 100 and the second printing unit 300 is reduced after being overlapped. And as the second printing unit 300 and the scanning unit 500 are juxtaposed above the first printing unit 100, the height of the multi-function peripheral device can be further reduced, thus the size of the multi-function peripheral is reduced.

In practice, the first printing module 130 of the first printing unit 100 can be a laser printing module, which meets the requirement of large-quantity black and white printing together with the paper feed tray 110 used for storing papers. The second printing module 350 can be a color inkjet printing module, which meets the requirement of color printing. As the quantity of color printing is relatively small, the paper feed tray can be omitted, and the paper can be picked up from the paper support on the side, which further reduces the space that the paper feed tray occupies.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A multi-function peripheral device, comprising:
a first printing unit;
a second printing unit, disposed above the first printing unit, wherein a paper support for supporting a piece of paper is disposed on a first side of the second printing unit, such that the piece of paper enters the second printing unit from the side of the second printing unit; and
a scanning unit, disposed on a second side of the second printing unit, and juxtaposed above the first printing unit together with the second printing unit.

2. The multi-function peripheral device as claimed in claim 1, further comprising a paper exit, wherein the paper exit is disposed between the first printing unit and the second printing unit, and the paper exit is shared by the first printing unit and the second printing unit.

3. The multi-function peripheral device as claimed in claim 1, further comprising a paper exit, wherein the first printing unit has a first paper feeding track, the second printing unit has a second paper feeding track, and a paper-out end of the first paper feeding track and a paper-out end of the second paper feeding track are connected to the paper exit.

4. The multi-function peripheral device as claimed in claim 3, wherein the first printing unit comprises a paper feed tray disposed at the bottom of the first printing unit, and a paper-in end of the first paper feeding track is connected to the paper feed tray.

5. The multi-function peripheral device as claimed in claim 3, wherein a paper-in end of the second paper feeding track is disposed on one side of the second printing unit, corresponding to the side of the device.

6. The multi-function peripheral device as claimed in claim 5, wherein the paper-in end is connected to the paper support.

7. The multi-function peripheral device as claimed in claim 3, wherein the first printing unit further comprises a first printing module disposed in a middle section of the first paper feeding track for performing a printing process when a piece of paper passes the first printing module via the first paper feeding track.

8. The multi-function peripheral device as claimed in claim 7, wherein the first printing module is a laser printing module.

9. The multi-function peripheral device as claimed in claim 3, wherein the second printing unit further comprises a second printing module disposed in a middle section of the second paper feeding track for performing a printing process when a piece of paper passes the second printing module via the second paper feeding track.

10. The multi-function peripheral device as claimed in claim 9, wherein the second printing module is an inkjet printing module.
